(19) United States
(12) Patent Application Publication
(10) Pub. No.: US 2025/0330316 A1
(43) Pub. Date: Oct. 23, 2025

(54) BLOCKCHAIN TECHNIQUE-BASED SOFTWARE AUTHORIZATION METHOD, SOFTWARE AUTHENTICATION METHOD, AND AUTHENTICATION SERVER

(71) Applicant: Wistron Corporation, New Taipei City (TW)

(72) Inventors: Bo-Hong HE, New Taipei City (TW); Yi-Tsung CHENG, New Taipei City (TW); Hsien-Ta WU, New Taipei City (TW)

(21) Appl. No.: 18/758,293

(22) Filed: Jun. 28, 2024

(30) Foreign Application Priority Data
Apr. 22, 2024 (TW) 113114993

(51) Int. Cl. H04L 9/14; G06F 21/73; H04L 9/00

(52) U.S. Cl. CPC H04L 9/14; G06F 21/73; H04L 9/50

(57) ABSTRACT

A blockchain technique-based software authorization method, a software authentication method, and an authentication server are provided. The authentication server includes a communication circuit and a control circuit. The communication circuit is configured to connect to a blockchain. The control circuit is electrically connected to the communication circuit and is configured to perform the software authorization method. The software authorization method includes: receiving client information of a software pack from a client; establishing blockchain information and software information of the software pack according to the client information; and sending a blockchain trade according to the blockchain information and the software information to generate a first trade block corresponding to the blockchain, where the first trade block includes published software information corresponding to the software information.

### CROSS-REFERENCE TO RELATED APPLICATION

This non-provisional application claims priority under 35 U.S.C. § 119 (a) to patent application No. 113114993 filed in Taiwan, R.O.C. on Apr. 22, 2024, the entire contents of which are hereby incorporated by reference.

### BACKGROUND

### Technical Field

The present invention relates to a blockchain technique, in particular to a blockchain technique-based software authorization method, a software authentication method, and an authentication server.

### Related Art

In the era when the Internet was not popular, users had to purchase genuine software and authorization keys from software companies before the users could install and use software on computers. With the advancement of Internet techniques, users can download software through the Internet, and software companies have switched to authorize the users to use software through online purchasing. However, the popularization of the Internet has led to leak of authorization keys, and makes it difficult for the software companies to avoid rampant pirated software. In addition, the rise of Internet hackers has also led to serious information security problems, such as a risk that client information of the users managed by the software companies may be stolen or tampered with.

### SUMMARY

In view of this, the inventors propose a blockchain technique-based software authorization method, a software authentication method, and an authentication server. Existing software authorization mechanisms are integrated with a blockchain technique to improve security and complexity of the software authorization mechanisms, and operations of the software authorization mechanisms are also simplified and accelerated.

In some embodiments, a blockchain technique-based software authorization method is performed by an authentication server connected to a blockchain. The software authorization method includes: receiving client information of a software pack from a client; establishing blockchain information and software information of the software pack according to the client information; and sending a blockchain trade according to the blockchain information and the software information to generate a first trade block corresponding to the blockchain, where the first trade block includes published software information corresponding to the software information.

In some embodiments, the software authorization method further includes: checking whether the first trade block is successfully written into the blockchain; and sending a purchase success notice to the client in response to the first trade block being successfully written into the blockchain.

In some embodiments, the software authorization method further includes: transmitting the blockchain information to a host.

In some embodiments, the software authorization method further includes: receiving hardware information of the host from the host, where the host is associated with the client; and sending another blockchain trade according to the blockchain information and the hardware information to generate a second trade block corresponding to the blockchain, where the second trade block includes published hardware information corresponding to the hardware information.

In some embodiments, the hardware information includes a system universally unique identifier (UUID) of the host, a system serial number (SN) of the host, and a motherboard SN of the host.

In some embodiments, the blockchain information includes a public key of the blockchain, a private key of the blockchain, and an address of the blockchain.

In some embodiments, the software information includes a software name of the software pack, a software version of the software pack, and an authorization period of the software pack.

In some embodiments, a consensus mechanism of the blockchain is a proof of authority (PoA).

In some embodiments, a consensus mechanism of the blockchain is a proof of work (PoW) or a proof of stake (PoS).

In some embodiments, a blockchain technique-based software authentication method is performed by a host associated with a client. The host is installed with a software pack, and the software pack has software information. The software authentication method includes: initiating an authentication program to establish a connection between the host and a blockchain; querying a first trade block associated with the client from the blockchain, where the first trade block includes published software information corresponding to the software information; authenticating whether the software information matches the published software information; and executing the software pack in response to the software information matching the published software information.

In some embodiments, the host has hardware information. The software authentication method further includes: querying a second trade block associated with the client from the blockchain, where the second trade block includes published hardware information corresponding to the hardware information; and authenticating whether the hardware information matches the published hardware information. The step of executing the software pack is responsive to the hardware information matching the published hardware information and the software information matching the published software information.

In some embodiments, the software authentication method further includes: authenticating an offline time of the host in response to the hardware information matching the published hardware information; and closing the authentication program in response to the offline time being longer than an offline time limit.

In some embodiments, the host is a node in the blockchain. The software authentication method further includes: synchronizing a plurality of trade blocks stored at other nodes in the blockchain after the connection is interrupted and the connection is established again.

In some embodiments, an authentication server includes a communication circuit and a control circuit. The communication circuit is configured to connect to a blockchain. The control circuit is electrically connected to the communication circuit and configured to perform the software authorization method in any of the above-mentioned embodiments.

In some embodiments, a blockchain technique-based software authorization method is performed by an authentication server connected to a blockchain. The software authorization method includes: sending a blockchain trade according to blockchain information and software information to generate a first trade block corresponding to the blockchain, where the first trade block includes published software information corresponding to the software information; and sending another blockchain trade according to the blockchain information and hardware information to generate a second trade block corresponding to the blockchain, where the second trade block includes published hardware information corresponding to the hardware information. The blockchain information and the software information are associated with client information of a software pack, the hardware information is associated with a host, and the host is associated with a client.

In some embodiments, a blockchain technique-based software authentication method is performed by a host associated with a client. The host is installed with a software pack and connected to a blockchain, and the software pack has software information. The software authentication method includes: querying a first trade block associated with the client from the blockchain, where the first trade block includes published software information corresponding to the software information; authenticating whether the software information matches the published software information; querying a second trade block associated with the client from the blockchain, where the second trade block includes published hardware information corresponding to the hardware information; and authenticating whether the hardware information matches the published hardware information, where the hardware information is associated with the host.

### BRIEF DESCRIPTION OF THE DRAWINGS

FIG. 1 is a module block diagram of an embodiment of an authentication server and a host;

FIG. 2 is a timing diagram of an embodiment of each device in FIG. 1;

FIG. 3 is an operation flowchart of an embodiment of an authentication server and a client in FIG. 1;

FIG. 4 is an operation flowchart of an embodiment of an authentication server and a host in FIG. 1;

FIG. 5 is an operation flowchart of a first embodiment of an authentication server in FIG. 1;

FIG. 6 is an operation flowchart of an embodiment after step S120 in FIG. 5;

FIG. 7 is an operation flowchart of an embodiment after step S140 in FIG. 6;

FIG. 8 is an operation flowchart of an embodiment after step S150 in FIG. 7;

FIG. 9 is an operation flowchart of a first embodiment of a host in FIG. 1;

FIG. 10 is an operation flowchart of an embodiment after step S220 in FIG. 9;

FIG. 11 is an operation flowchart of an embodiment after step S250 in FIG. 10;

FIG. 12 is an operation flowchart of an embodiment after step S230 in FIG. 9 or step S260 in FIG. 10;

FIG. 13 is an operation flowchart of a second embodiment of an authentication server in FIG. 1; and

FIG. 14 is an operation flowchart of a second embodiment of a host in FIG. 1.

### DETAILED DESCRIPTION

The term “include” mentioned herein is an open term and should therefore be interpreted as “include but not limit to”. As used herein, an “electrical connection” means a “direct” or “indirect” electrical contact between two or more elements. The terms “first”, “second”, and “another” used herein are configured to distinguish the elements referred to, and are not configured to rank or limit the differences of the elements referred to, unless otherwise specified, nor are they configured to limit the scope of the present invention.

The elements or operations used in the singular form and described in the term “a/an” shall be understood as not excluding a plurality of elements or operations unless such exclusion has been expressly stated. In addition, “embodiments” referred to herein are not intended to be construed as excluding the existence of other embodiments that also include the aforementioned technical features.

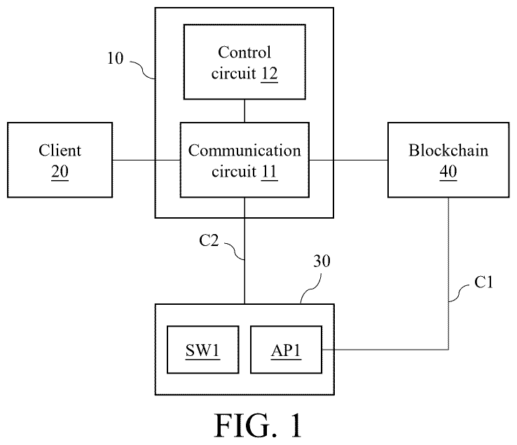

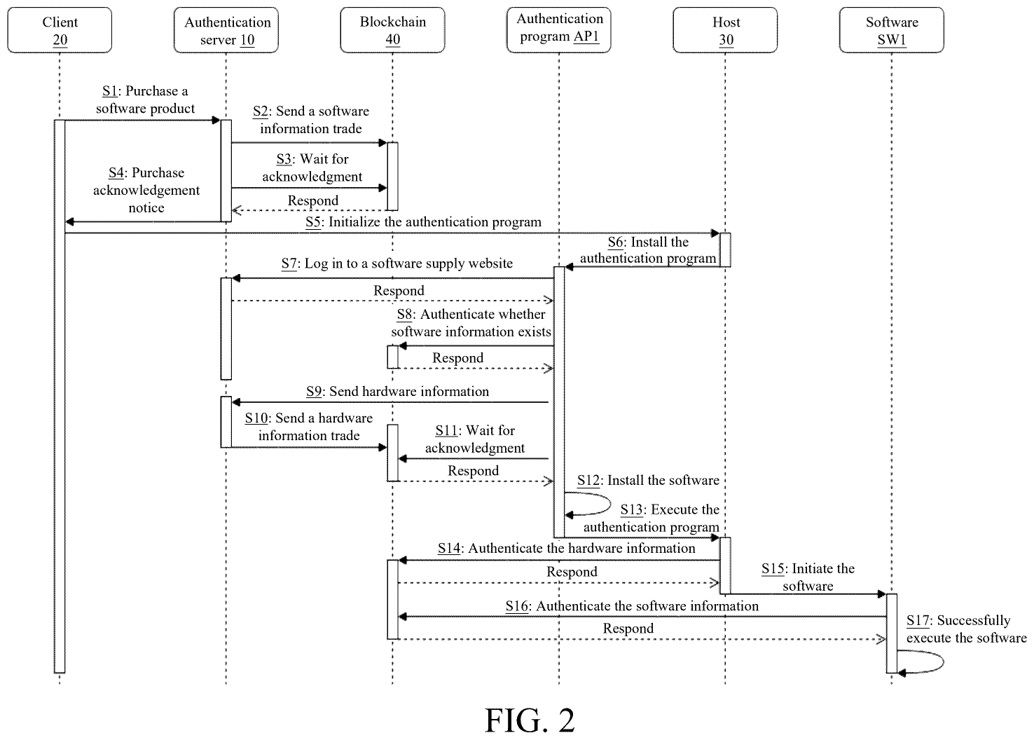

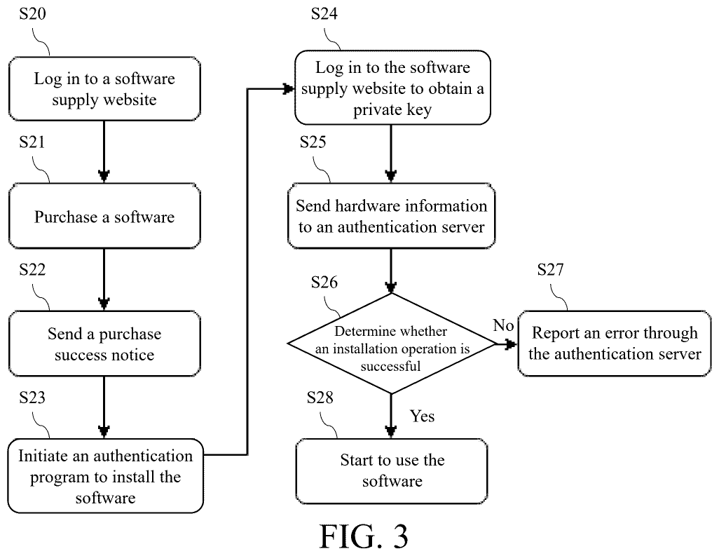

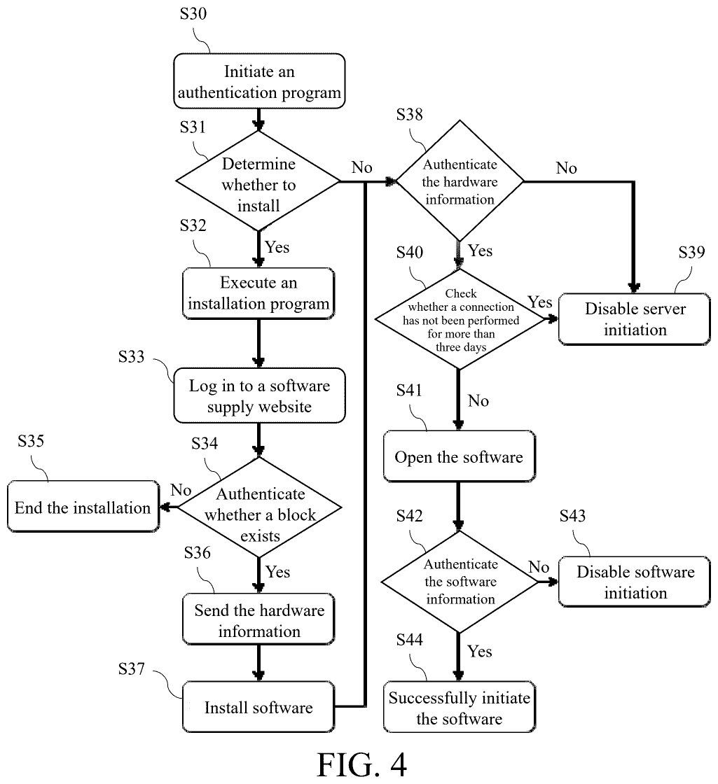

Reference is made to FIG. 1 to FIG. 4. FIG. 1 is a module block diagram of an embodiment of an authentication server 10 and a host 30, FIG. 2 is a timing diagram of an embodiment of each device in FIG. 1, FIG. 3 is an operation flowchart of an embodiment of the authentication server 10 and a client 20 in FIG. 1, and FIG. 4 is an operation flowchart of an embodiment of the authentication server 10 and the host 30 in FIG. 1. In some embodiments, according to the steps shown in FIG. 2 to FIG. 4, the authentication server 10 may authorize a software pack to be executed by the host 30, and the host 30 may be connected to a blockchain 40 to authenticate the validity of the software pack.

In some embodiments, the software pack may be single software SW1 or may include a plurality of software SW1. This is not limited herein. For the convenience of illustration, the software pack being single software SW1 will be explained below, but this is not intended to limit the number of software SW1 in the software pack.

The authentication server 10 includes a communication circuit 11 and a control circuit 12. The communication circuit 11 is configured to connect to the blockchain 40. For example, in some embodiments, the blockchain 40 exists in a local area network, and the authentication server 10 may be connected to the local area network through the communication circuit 11. Therefore, the authentication server 10 may be connected to the blockchain 40 through the communication circuit 11. In some embodiments, the communication circuit 11 may be a hardware element having a communication function, for example but not limited to, a wired network chip, a wireless network (Wi-Fi) chip, a Bluetooth chip, or a two-in-one communication chip having both a Wi-Fi function and a Bluetooth function.

The control circuit 12 is electrically connected to the communication circuit 11. In some embodiments, the control circuit 12 may be a hardware element having control and arithmetic functions, for example but not limited to, a central processing unit (CPU), a microprocessor, a digital signal processor (DSP), a complex programmable logic device (CPLD), a field programmable gate array (FPGA), an application specific integrated circuit (ASIC), or a microcontroller unit (MCU).

In some embodiments, the host 30 may be a device having a communication function, for example but not limited to, a smartphone, a desktop computer, a laptop computer, a tablet computer, or a server computer. In some embodiments, the host 30 has hardware information, where the hardware information includes, but is not limited to, a system UUID, a system SN, and a motherboard SN of the host 30.

In some embodiments, the blockchain 40 has a plurality of trade blocks, and each trade block includes hardware information associated with the host 30 on which the software SW1 purchased by one or more users is installed and software information of the software SW1 purchased by the one or more users. In other words, the authentication server 10 records and manages authorization information (including the hardware information and the software information) of the software SW1 authorized to the user through the blockchain 40.

In some embodiments, a consensus mechanism of the blockchain 40 is a proof of authority (PoA). The PoA is a completely centralized consensus, where only a user authorized to be a validator can access the blockchain 40 (hereinafter referred to as a PoA blockchain 40) of which the consensus mechanism is the PoA. Therefore, the PoA blockchain 40 has better controllability than a blockchain having a decentralized consensus. In addition, the PoA blockchain 40 has a higher trade speed than blockchains having other consensus mechanisms. Therefore, in some embodiments, the authentication server 10 may take advantage of the characteristics of the PoA to speed up blockchain trades, and the authentication server 10 may act as a manager of the blockchain 40 to determine which electronic devices may access the PoA blockchain 40. The following will illustrate the operation of the blockchain 40 in response to the consensus mechanism being the PoA.

It should be noted that according to different usage scenarios, the blockchain 40 may alternatively adopt a decentralized consensus. In other words, in other embodiments, the consensus mechanism of the blockchain 40 may be, but is not limited to, a proof of work (PoW) or a proof of stake (PoS). For example, when better security is required for the blockchain 40, the consensus mechanism may be the PoW, where the PoW is to authenticate trades through miners solving complex mathematical problems. Alternatively, when less energy is required to be consumed for the blockchain 40, the consensus mechanism may be the POS, where the POS is to allocate the right to authenticate trades through the number of tokens held by a node.

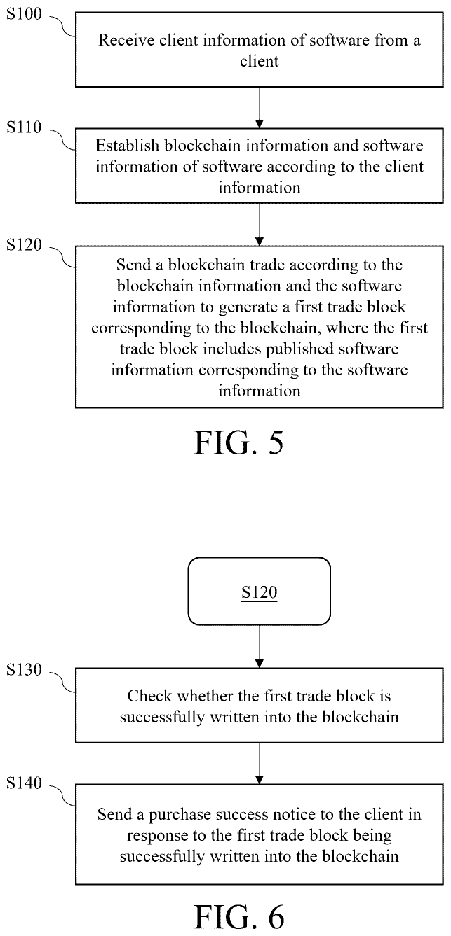

For convenience of illustration, operation flowcharts of FIG. 2 to FIG. 4 will be explained in detail below with the operation flowchart of each device in FIG. 1. Reference is made to FIG. 5 to FIG. 8. FIG. 5 to FIG. 8 are operation flowcharts of some embodiments of the authentication server 10. As shown in FIG. 5, the client 20 is first connected to the authentication server 10 to purchase the software SW1, so that the control circuit 12 receives client information of the software SW1 from the client 20 (step S100, corresponding to steps S1, S20, and S21). For example, in some embodiments, the client 20 may be an electronic device having communication and web browsing functions for connecting to the authentication server 10 and registering a login account number and a login password at a software supply website provided by the authentication server 10 to log in to a membership of the user. In other words, the user purchases the software SW1 at the software supply website by operating the client 20. Therefore, the control circuit 12 receives, from the client 20, the client information inputted by the user when purchasing the software SW1, where the client information includes, but is not limited to, an organization name, a contact, a contact number, a contact e-mail, a contact address, and/or a purchase time of the user.

In some embodiments, the user may log in to the software supply website of the authentication server 10 through the client 20 to purchase the software SW1, or may connect to the authentication server 10 through another electronic device (e.g., a host) that also has communication and web browsing functions to purchase the software SW1. In other words, the client 20 and the host 30 may be a same electronic device, or may be two different electronic devices. In this embodiment, the client 20 and the host 30 are two different electronic devices.

After step S100, the control circuit 12 establishes blockchain information of the user and software information of the software SW1 according to the client information (step S110, corresponding to step S2). In some embodiments, establishing the blockchain information of the user means adding an account to the blockchain 40. The blockchain information includes, but is not limited to, a public key, a private key, and a blockchain address of the blockchain 40 corresponding to the new account. In some embodiments, the software information includes, but is not limited to, a software name, a software version, and an authorization period of the software SW1. In some embodiments, the authorization period includes an authorization start time and an authorization termination time. In some embodiments, the authorization period includes an authorization termination time, and the authorization period is an authorization time limit.

After step S110, the control circuit 12 sends a blockchain trade according to the blockchain information and the software information to generate a first trade block corresponding to the blockchain 40, where the first trade block includes published software information corresponding to the software information (step S120, corresponding to step S2). In other words, the published software information corresponding to the software information is stored in the first trade block, and benefiting from the immutability of the blockchain 40, the published software information may be securely protected. In some embodiments, for the blockchain trade, the authentication server 10 serves as a trade sender, and the newly added account serves as a trade receiver. In some embodiments, the published software information stored in the first trade block is symmetrically encrypted by the private key of the newly added account. Therefore, the content cannot be viewed by a person who does not hold the corresponding private key.

After step S120 (as shown in FIG. 6), the control circuit 12 checks whether the first trade block is successfully written into the blockchain 40 (step S130, corresponding to step S3) to ensure the validity and correctness of the trade. In response to the first trade block being successfully written into the blockchain 40, the control circuit 12 receives a response from the blockchain 40 and sends a purchase success notice to the client 20 (step S140, corresponding to steps S4 and S22) to notify the client 20 of successful purchasing of the software SW1.

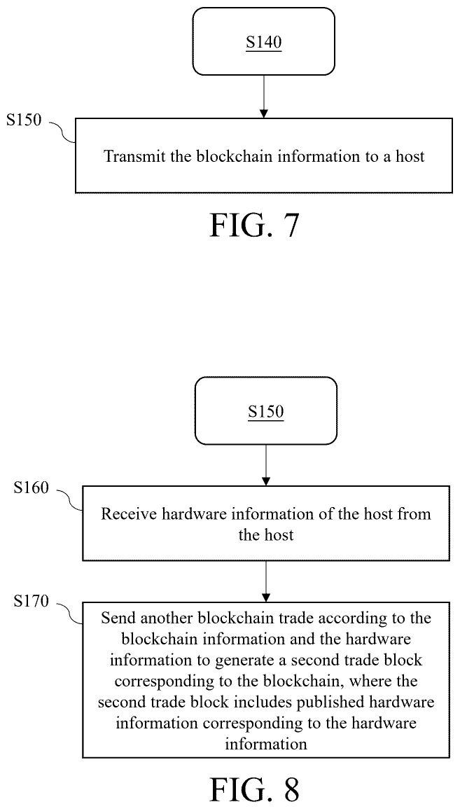

After step S140 (as shown in FIG. 7), when the user successfully purchases the software SW1 through the client 20, the user may log in to the software supply website of the authentication server 10 through the host 30, and obtain information for accessing the blockchain 40, such as a public key, a private key, and a connection address after receiving the response from the blockchain 40 (corresponding to steps S7 and S24). In other words, the control circuit 12 transmits the blockchain information to the host 30 (step S150), so that the user obtains the blockchain information through the client 20. Here, the user may access the blockchain 40 through the client 20 to receive a response from the blockchain 40, and use the private key to authenticate the validity of the first trade block on the blockchain 40 (corresponding to step S8).

In some embodiments, the user may use the software SW1 on the host 30 after obtaining, through the client 20, a hardware authorization of a hardware device (i.e., the host 30) on which the software SW1 is to be executed. In other words, even if the user has purchased the software SW1 from the authentication server 10 through the client 20, the user can only use the software SW1 on the hardware-authorized host 30 and cannot use the software SW1 on other devices not subjected to hardware authorization. Therefore, after step S150 (as shown in FIG. 8), the control circuit 12 receives the hardware information of the host 30 from the host 30 (step S160, corresponding to steps S9 and S25), and sends another blockchain trade according to the blockchain information and the hardware information to generate a second trade block corresponding to the blockchain 40, where the second trade block includes published hardware information corresponding to the hardware information (step S170, corresponding to step S10). In other words, the published hardware information corresponding to the hardware information is stored in the second trade block, and benefiting from the immutability of the blockchain 40, the published hardware information may be securely protected. In some embodiments, for the another blockchain trade, the authentication server 10 serves as a trade sender, and the newly added account serves as a trade receiver. In some embodiments, the published hardware information stored in the second trade block is symmetrically encrypted by the private key of the newly added account. Therefore, the content cannot be viewed by a person who does not hold the corresponding private key. Through the processes of steps S160 and S170, the authentication server 10 may authorize the client 20 to use the software SW1 on the host 30.

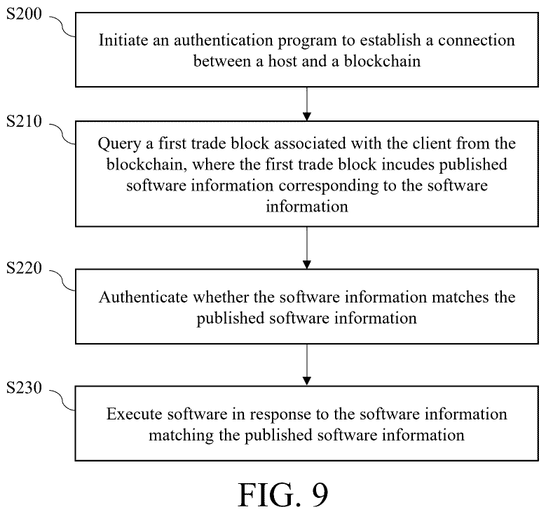

Reference is made to FIG. 9 to FIG. 12. FIG. 9 to FIG. 12 are operation flowcharts of some embodiments of the host 30. When the host 30 completes the hardware authorization (corresponding to step S10), the host 30 checks whether the second trade block is successfully written into the blockchain 40 (corresponding to step S11). After receiving the response from the blockchain 40, the user may install an authentication program AP1 for authenticating the validity of the software SW1 (i.e., software authentication) on the host 30 (corresponding to steps S5, S6, and S12), and install the software SW1 through the authentication program AP1 (corresponding to step S23). In some embodiments, when the user is unable to install the authentication program AP1 or the software SW1 on the host 30, the user may log in to the software supply website of the authentication server 10 to report the installation error to relevant customer service personnel (corresponding to steps S26 and S27).

As shown in FIG. 9, the host 30 first initiates the authentication program AP1 to establish a connection C1 between the host 30 and the blockchain 40 (step S200, corresponding to step S13). At this moment, the authentication server 10 authorizes the host 30 to become one validator of the blockchain 40 (i.e., a node of the blockchain 40), so that the host 30 participates in the PoA consensus and accesses the blockchain 40. Next, the host 30 queries the first trade block associated with the client 20 (the newly added account) from the blockchain 40 through the authentication program AP1 (step S210). In some embodiments, the authentication program AP1 may decrypt the contents of the first trade block according to the private key obtained by the user to obtain the published software information stored in the first trade block.

After step S210, the host 30 authenticates whether the software information of the software SW1 matches the published software information through the authentication program AP1 (step S220, corresponding to step S16). When the software information of the software SW1 matches the published software information so that the host 30 receives a response from the blockchain 40, it means that the user has purchased the software-authorized software SW1. Therefore, the user may execute the software SW1 on the host 30 in response to the software information matching the published software information (step S230, corresponding to steps S17 and S28).

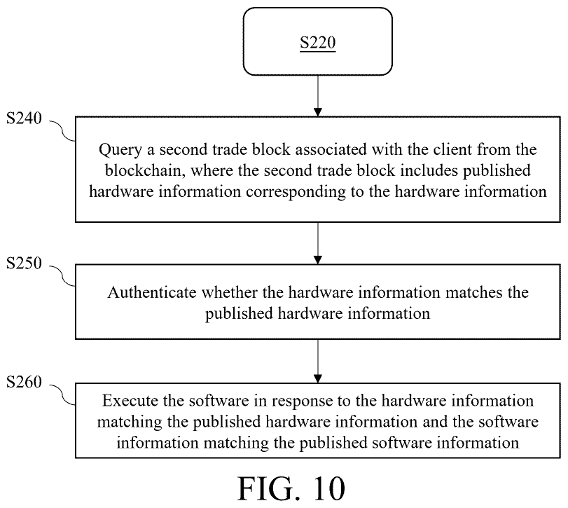

In some embodiments, the authentication program AP1 is required to further authenticate the validity of the host 30 (i.e., hardware authentication) before the software SW1 can be executed. Therefore, after step S220 (as shown in FIG. 10), the host 30 queries the second trade block associated with the client 20 (the aforementioned newly added account) from the blockchain 40 through the authentication program AP1 (step S240). In some embodiments, the authentication program AP1 may decrypt the contents of the second trade block according to the private key obtained by the user to obtain the published software information stored in the second trade block.

After step S240, the host 30 authenticates whether the hardware information of the host 30 matches the published hardware information through the authentication program AP1 (step S250, corresponding to step S14). When the hardware information of the host 30 matches the published hardware information so that the host 30 receives a response from the blockchain 40, it means that the user operates the hardware-authorized host 30. Therefore, in response to the hardware information matching the published hardware information and the software information matching the published software information, the user may execute the software SW1 on the host 30 (step S260, corresponding to steps S15 and S17).

In other embodiments, the authentication program AP1 may first perform hardware authentication on the host 30 (including steps S240 and S250), and then perform software authentication on the software SW1 (including steps S210 and S220). In other words, the authentication program AP1 does not limit the sequence of the step of hardware authentication and the step of software authentication. In addition, in some embodiments, when at least one of the hardware authentication or the software authentication fails, the authentication program AP1 is forcibly closed so that the user cannot initiate the software SW1 on the host 30. In other words, when both the hardware authentication on the host 30 and the software authentication on the software SW1 are passed, the user can execute the software SW1 on the host 30.

In some embodiments, the authentication program AP1 may be, but is not limited to, remote access software or virtual private network (VPN) connection software. In other embodiments, the authentication program AP1 may be packaged into the software SW1. For example, when the user initiates the software SW1 on the host 30, the authentication program AP1 is initiated beforehand for the hardware authentication and the software authentication.

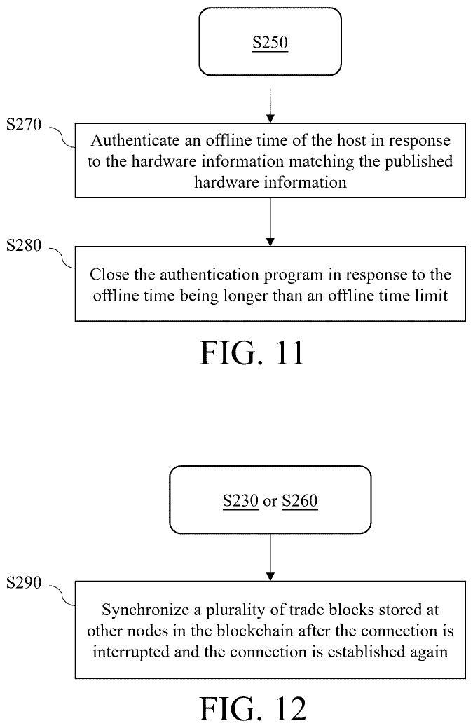

Reference is made to FIG. 11. FIG. 11 is an operation flowchart of other embodiments of the host 30. In some embodiments, the authentication program AP1 may also be configured to check an offline time of the host 30 to ensure that the host is connected to the blockchain 40 to update information when the user operates the host 30. In other words, the offline time of the host 30 is time when the host 30 is not connected to the blockchain 40. Here, after step S250 (as shown in FIG. 11), the host 30 authenticates the offline time of the host 30 through the authentication program AP1 in response to the hardware information matching the published hardware information (step S270). Further, in response to the offline time being longer than an offline time limit, the host 30 closes the authentication program AP1 (step S280) so that the user cannot execute the software SW1 on the host 30. In some embodiments, the offline time limit is, for example but not limited to, 3 days or 5 days. In other words, the client 20 must connect the host 30 to the blockchain 40 before the offline time of the host 30 is longer than the offline time limit, otherwise the software SW1 cannot continue to be executed on the host 30 in the future.

In some embodiments, since the host 30 is regarded as a node in the blockchain 40, the host 30 stores a trade block of the host and a plurality of trade blocks stored at other nodes on the blockchain 40. Here, after step S230 or step S260 (as shown in FIG. 12), when the connection C1 between the host 30 and the blockchain 40 is interrupted and the connection C1 is established again, the host 30 synchronizes the plurality of trade blocks stored at the other nodes in the blockchain 40 (step S290) to ensure that the host 30 stores the latest version of information. In some embodiments, the host 30 may form another LAN to establish a blockchain side chain of the blockchain 40, thereby enabling a more secure double-layer blockchain mechanism. Here, the host 30 may store information or data with high confidentiality in the blockchain side chain to achieve a more secure protection mechanism.

In some embodiments, when the host 30 initiates the authentication program AP1, a connection C2 between the host 30 and the authentication server 10 may be established to perform a variety of functions. For example, when the host 30 initiates the authentication program AP1 to connect to the authentication server 10, the host 30 may transmit a current version of the software SW1 to the authentication server 10, so that the authentication server 10 checks whether the current version of the software SW1 is the latest version. If the current version of the software SW1 is not the latest version, the authentication server 10 updates the software SW1 on the host 30.

In some embodiments, the user may log in to the software supply website of the authentication server 10 through the client 20 or host 30 to modify the authorization period of the software SW1. For example, the user may submit an extension application to extend the authorization period of the software SW1 or a termination application to terminate the authorization of the software SW1 in advance. At this moment, the control circuit 12 of the authentication server 10 sends another blockchain trade to generate a third trade block corresponding to the blockchain 40 according to the extension application or the termination application, where the third trade block includes the modified authorization period of the software SW1.

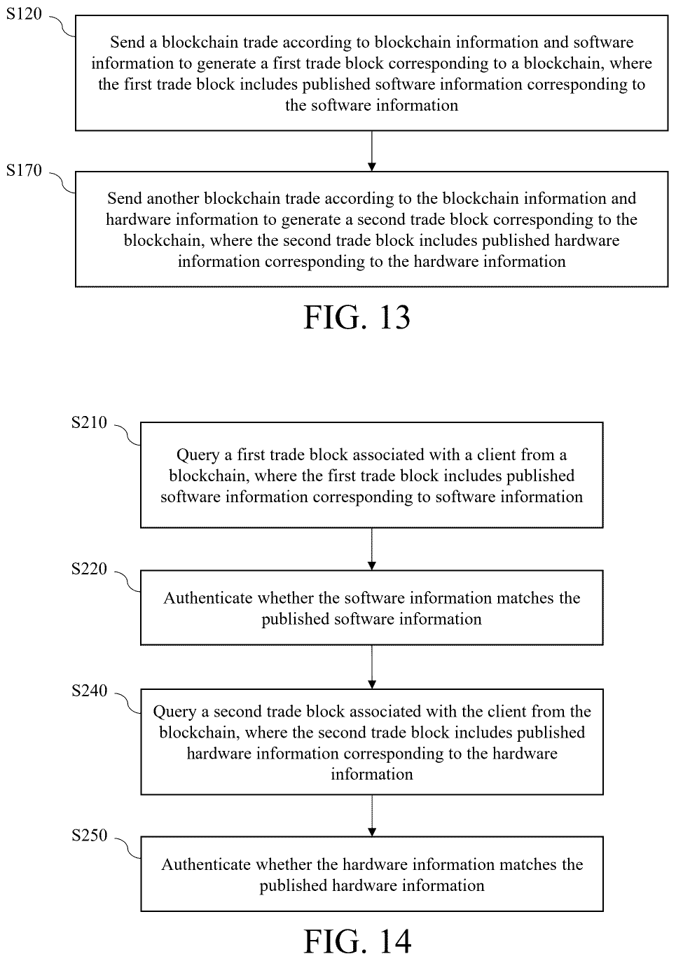

Referring to FIG. 13, in some embodiments, when the authentication server 10 has obtained the blockchain information, the software information, and the hardware information in advance, the authentication server 10 may directly create blocks associated with the software information and blocks associated with the hardware information to perform blockchain trades. It should be noted that the sequence of the step of sending the blockchain trade of the software information (step S120) and the step of sending the blockchain trade of the hardware information (step S170) is exchangeable. In other words, in some embodiments, the authentication server 10 may send the blockchain trade associated with the hardware information after sending the blockchain trade associated with the software information (as shown in FIG. 13). In other embodiments, the authentication server 10 may send the blockchain trade associated with the software information after sending the blockchain trade associated with the hardware information (not shown).

Referring to FIG. 14, in some embodiments, when the host 30 has obtained the blockchain information, the software information, and the hardware information in advance, the host 30 may directly perform software authentication associated with the software information and hardware authentication associated with the hardware information. It should be noted that the sequence of the step of authenticating the software information (steps S210 and S220) and the step of authenticating the hardware information (steps S240 and S250) is exchangeable. In other words, in some embodiments, the host 30 may authenticate the hardware information after authenticating the software information (as shown in FIG. 14). In other embodiments, the host 30 may authenticate the software information after authenticating the hardware information (not shown).

In summary, according to any embodiment, the blockchain technique-based software authorization method, the software authentication method, and the authentication server manage, by using a blockchain, authorization information of software purchased by each client. Benefiting from the characteristics of the blockchain, the authentication server has a better protection mechanism to ensure the security of the authorization information of each client. In addition, due to a high trade speed of the blockchain, a host may quickly perform software authentication to improve the convenience of operation, and the validity of software purchased by users may also be ensured.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A blockchain technique-based software authorization method, performed by an authentication server connected to a blockchain, the software authorization method comprising:
receiving client information of a software pack from a client;
establishing blockchain information and software information of the software pack according to the client information; and
sending a blockchain trade according to the blockchain information and the software information to generate a first trade block corresponding to the blockchain, wherein the first trade block comprises published software information corresponding to the software information.

2. The software authorization method according to claim 1, further comprising:
checking whether the first trade block is successfully written into the blockchain; and
sending a purchase success notice to the client in response to the first trade block being successfully written into the blockchain.

3. The software authorization method according to claim 2, further comprising:
transmitting the blockchain information to a host.

4. The software authorization method according to claim 3, further comprising:
receiving hardware information of the host from the host, wherein the host is associated with the client; and
sending another blockchain trade according to the blockchain information and the hardware information to generate a second trade block corresponding to the blockchain, wherein the second trade block comprises published hardware information corresponding to the hardware information.

5. The software authorization method according to claim 4, wherein the hardware information comprises a system universally unique identifier (UUID) of the host, a system serial number (SN) of the host, and a motherboard SN of the host.

6. The software authorization method according to claim 1, wherein the blockchain information comprises a public key of the blockchain, a private key of the blockchain, and an address of the blockchain.

7. The software authorization method according to claim 1, wherein the software information comprises a software name of the software pack, a software version of the software pack, and an authorization period of the software pack.

8. The software authorization method according to claim 1, wherein a consensus mechanism of the blockchain is a proof of authority (PoA).

9. The software authorization method according to claim 1, wherein a consensus mechanism of the blockchain is a proof of work (PoW) or a proof of stake (PoS).

10. A blockchain technique-based software authentication method, performed by a host associated with a client, wherein the host is installed with a software pack, and the software pack has software information, the software authentication method comprising:
initiating an authentication program to establish a connection between the host and a blockchain;
querying a first trade block associated with the client from the blockchain, wherein the first trade block comprises published software information corresponding to the software information;
authenticating whether the software information matches the published software information; and
executing the software pack in response to the software information matching the published software information.

11. The software authentication method according to claim 10, wherein the host has hardware information, the software authentication method further comprising:
querying a second trade block associated with the client from the blockchain, wherein the second trade block comprises published hardware information corresponding to the hardware information; and
authenticating whether the hardware information matches the published hardware information,
wherein the step of executing the software pack is responsive to the hardware information matching the published hardware information and the software information matching the published software information.

12. The software authentication method according to claim 11, further comprising:
authenticating an offline time of the host in response to the hardware information matching the published hardware information; and
closing the authentication program in response to the offline time being longer than an offline time limit.

13. The software authentication method according to claim 10, wherein the host is a node in the blockchain, the software authentication method further comprising:
synchronizing a plurality of trade blocks stored at other nodes in the blockchain after the connection is interrupted and the connection is established again.

14. An authentication server, comprising:
a communication circuit, configured to connect to a blockchain; and
a control circuit, electrically connected to the communication circuit and configured to perform the following steps:
receiving client information of a software pack from a client;
establishing blockchain information and software information of the software pack according to the client information; and
sending a blockchain trade according to the blockchain information and the software information to generate a first trade block corresponding to the blockchain, wherein the first trade block comprises published software information corresponding to the software information.

15. The authentication server according to claim 14, wherein the control circuit is further configured to perform the following steps:
checking whether the first trade block is successfully written into the blockchain; and
sending a purchase success notice to the client in response to the first trade block being successfully written into the blockchain.

16. The authentication server according to claim 15, wherein the control circuit is further configured to perform the following steps:
transmitting the blockchain information to a host.

17. The authentication server according to claim 16, wherein the control circuit is further configured to perform the following steps:
receiving hardware information of the host from the host, wherein the host is associated with the client; and
sending another blockchain trade according to the blockchain information and the hardware information to generate a second trade block corresponding to the blockchain, wherein the second trade block comprises published hardware information corresponding to the hardware information.

18. The authentication server according to claim 17, wherein the hardware information comprises a system universally unique identifier (UUID) of the host, a system serial number (SN) of the host, and a motherboard SN of the host.

19. The authentication server according to claim 14, wherein the blockchain information comprises a public key of the blockchain, a private key of the blockchain, and an address of the blockchain.

20. The authentication server according to claim 14, wherein the software information comprises a software name of the software pack, a software version of the software pack, and an authorization period of the software pack.

21. The authentication server according to claim 14, wherein a consensus mechanism of the blockchain is a proof of authority (PoA).

22. The authentication server according to claim 14, wherein a consensus mechanism of the blockchain is a proof of work (PoW) or a proof of stake (PoS).

23. A blockchain technique-based software authorization method, performed by an authentication server connected to a blockchain, the software authorization method comprising:
sending a blockchain trade according to blockchain information and software information to generate a first trade block corresponding to the blockchain, wherein the first trade block comprises published software information corresponding to the software information; and
sending another blockchain trade according to the blockchain information and hardware information to generate a second trade block corresponding to the blockchain, wherein the second trade block comprises published hardware information corresponding to the hardware information,
wherein the blockchain information and the software information are associated with client information of a software pack, the hardware information is associated with a host, and the host is associated with a client.

24. A blockchain technique-based software authentication method, performed by a host associated with a client, wherein the host is installed with a software pack and connected to a blockchain, and the software pack has software information, the software authentication method comprising:
querying a first trade block associated with the client from the blockchain, wherein the first trade block comprises published software information corresponding to the software information;
authenticating whether the software information matches the published software information;
querying a second trade block associated with the client from the blockchain, wherein the second trade block comprises published hardware information corresponding to the hardware information; and
authenticating whether the hardware information matches the published hardware information,
wherein the hardware information is associated with the host.
